(19) United States
(12) Patent Application Publication
(10) Pub. No.: US 2025/0289268 A1
(43) Pub. Date: Sep. 18, 2025

(54) WIRE WHEEL FOR TUBELESS TIRE

(71) Applicant: HOME CHEN TECHNOLOGY CO., LTD., Taichung City (TW)

(72) Inventors: PO YEN LAI, Taichung City (TW); Wei Hong Li, Taichung City (TW)

(73) Assignee: HOME CHEN TECHNOLOGY CO., LTD., Taichung City (TW)

(21) Appl. No.: 18/604,721

(22) Filed: Mar. 14, 2024

(51) Int. Cl. B60B 21/06; B60B 1/04

(52) U.S. Cl. CPC B60B 21/064; B60B 1/04

(57) ABSTRACT

A wire wheel for a tubeless tire has a wheel rim, multiple connecting pins, a hub, and multiple wire spokes. The wheel rim has multiple interior protrusions protruding inward and each having a mounting hole for receiving a corresponding connecting pin and a thickening portion adjacent to the mounting hole to enhance the strength of the wheel rim. Each connecting pin has a first connecting hole. The hub has connecting protrusions located on its periphery and divided into two groups, each group arranged circularly, and each connecting protrusion has two second connecting holes each forming a containing groove. Each wire spoke can be designed straight, has two opposite ends respectively connected to the first connecting hole and the second connecting hole aligned with each other, and has an engaging head and a leading portion configured to lead the engaging head into the containing groove.

### BACKGROUND OF THE INVENTION

### 1. Field of the Invention

The present invention relates to a wheel, and particularly to a wire wheel for a tubeless tire.

### 2. Description of Related Art

A wire wheel is a classic component of automobiles and motorcycles. Compared to common alloy wheels, the wire wheel has lower weight, higher structural strength, and higher elasticity.

For the sake of airtightness, a conventional wire wheel needs an inner tube to be mounted thereon inside a cover. Since wire spokes protrude from the periphery of a rim of the wire wheel, the wire spokes may puncture the inner tube under impact, which leads to air leakage and interferes with driving safety.

TW M246190 provides another conventional wire wheel having multiple steel plates; the multiple steel plates are disposed on an inner edge of the rim for the wire spokes to be connected thereto such that no component protrudes from the periphery of the rim. However, two opposite ends of the wire spokes need to be bent to be connected to corresponding steel plates, which causes the wire spokes to transfer forces via the bent portion and thereby reduces the performance of the wire wheel.

### SUMMARY OF THE INVENTION

The main objective of the present invention is to provide a wire wheel for a tubeless tire that prevents straight wire spokes without a bent portion from puncturing an inner tube and improves the performance of the wire wheel.

The wire wheel for a tubeless tire has a wheel rim, multiple connecting pins, a hub, and multiple wire spokes. The wheel rim has multiple interior protrusions protruding from an interior surface of the wheel rim and arranged circularly. Each one of the multiple interior protrusions has a mounting hole formed therein and a thickening portion formed on the interior surface. The mounting hole extends along an axial direction of the wire wheel, and the thickening portion is located between the mounting hole and the interior surface. Each one of the multiple connecting pins is received in the mounting hole of a respective one of the multiple interior protrusions and has a first connecting hole defined thereon. The hub is formed in one piece, is disposed at a center of the wheel rim, and has multiple connecting protrusions formed on a periphery of the hub and divided into two groups, each group arranged circularly. Each one of the multiple connecting protrusions has two second connecting holes defined therethrough, spaced from each other, and respectively extending along two different directions. Each one of the two second connecting holes is aligned with the first connecting hole of a respective one of the multiple connecting pins and forms a containing groove and a guiding surface. The containing groove is located at a side of said connecting protrusion away from the corresponding first connecting hole, and the guiding surface is annular and tapers from the containing groove toward the other side of said connecting protrusion. Each one of the multiple wire spokes is inclined toward a tangent direction of the hub and has a rim end, a hub end, an engaging head, and a leading portion. The rim end is mounted through a respective one of the multiple interior protrusions and connected to the first connecting hole of a respective one of the multiple connecting pins; the hub end is opposite to the rim end and connected to one of the two second connecting holes of a respective one of the multiple connecting protrusions. The engaging head is located on the hub end and engaged in the containing groove formed by the corresponding second connecting hole, and the leading portion is connected to the engaging head and tapers from the engaging head toward the rim end.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a wire wheel for a tubeless tire of a first preferred embodiment in accordance with the present invention;

FIG. 2 is an exploded view of one of multiple connecting pins and a respective one of multiple wire spokes of the wire wheel in FIG. 1;

FIG. 3 is a perspective view of a hub of the wire wheel in FIG. 1;

FIG. 4 is a sectional side view of the hub of the wire wheel in FIG. 1;

FIG. 5 is a partial sectional view depicting one of the multiple wire spokes connected to the corresponding connecting pin and the hub;

FIG. 6 is a partial sectional view of one of the multiple connecting pins and a respective one of multiple interior protrusions of a wheel rim of the wire wheel in FIG. 1;

FIG. 7 is a sectional view depicting two of the multiple connecting pins respectively engaged in adjacent two of the multiple interior protrusions of the wheel rim of the wire wheel in FIG. 1;

FIG. 8 is a partial sectional side view depicting said wire spokes connected to the hub;

FIG. 9 is an enlarged sectional view of one of the multiple wire spokes and a respective one of multiple connecting protrusions of the hub of the wire wheel in FIG. 1;

FIG. 10 is a perspective view of the wire wheel for a tubeless tire of a second preferred embodiment in accordance with the present invention;

FIG. 11 is a side view of the hub of the wire wheel for a tubeless tire in FIG. 10;

FIG. 12 is an enlarged view of FIG. 10; and

FIG. 13 is a sectional view of one of the multiple wire spokes connected to the corresponding connecting pin of the wire wheel for a tubeless tire in FIG. 10.

### DETAILED DESCRIPTION OF THE PREFERRED EMBODIMENT

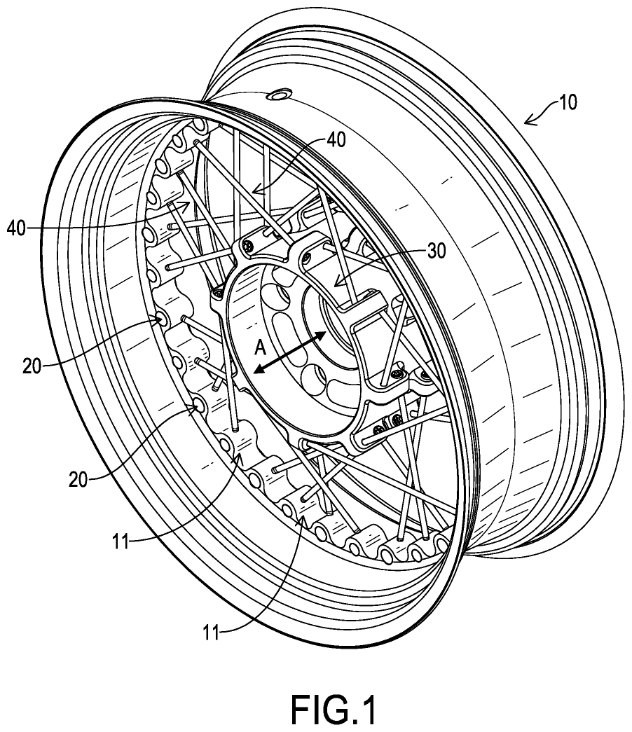

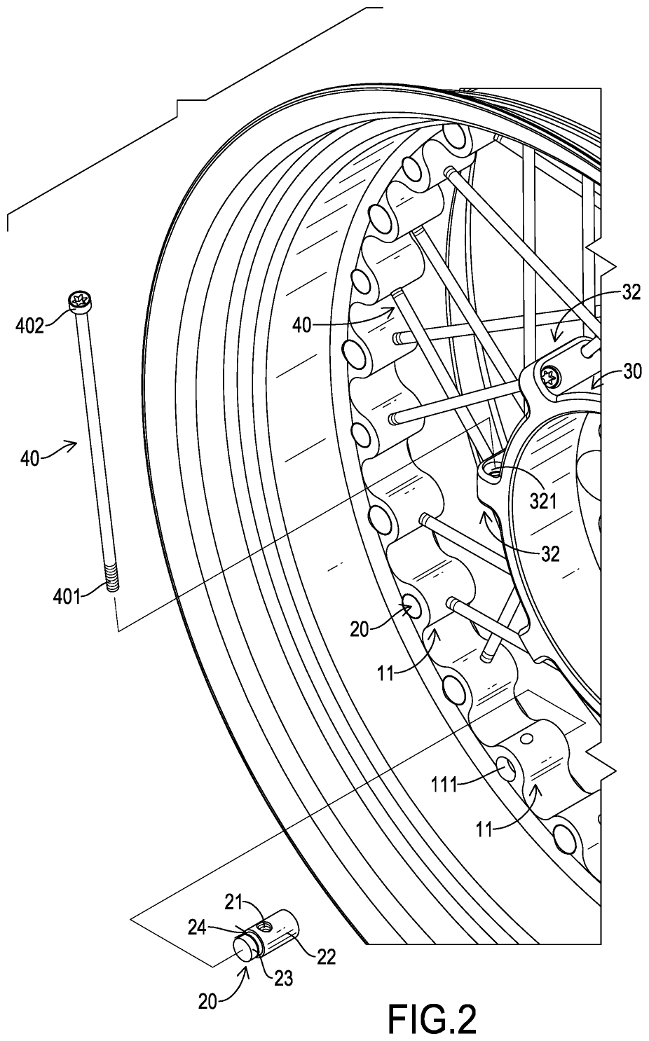

With reference to FIGS. 1 and 2, a wire wheel for a tubeless tire of a first preferred embodiment in accordance with the present invention has a wheel rim 10, multiple connecting pins 20, a hub 30, and multiple wire spokes 40. The wheel rim 10 and the hub 30 are respectively a periphery and a center of the wire wheel. The multiple wire spokes 40 are connected between the wheel rim 10 and the hub 30, and the multiple connecting pins 20 are configured to connect the multiple wire spokes 40 and the wheel rim 10.

With reference to FIGS. 1 and 2, the wheel rim 10 tapers from two opposite sides of the wheel rim 10 to a middle of the wheel rim 10, wherein the wheel rim 10 is formed by forging in the preferred embodiment; in other embodiments, the wheel rim 10 may be formed by another conventional process according to its material, which is not limited to the preferred embodiment. In the preferred embodiment, the wheel rim 10 formed by forging has a greater strength and a lower weight in comparison with conventional wheel rims formed by casting

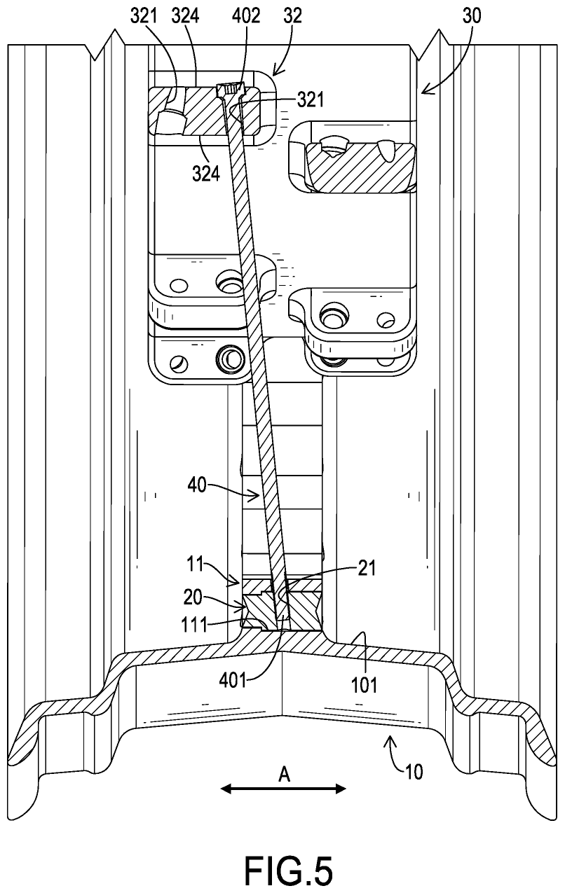

With reference to FIGS. 2 and 5, the wheel rim 10 has multiple interior protrusions 11 protruding from an interior surface 101 of the wheel rim 10 toward the hub 30 (i.e. toward an axis of the wheel rim 10) and arranged circularly; specifically, the interior surface 101 is located at the middle of the wheel rim 10 and surrounds the hub 30. The multiple interior protrusions 11 are arranged circularly and at equal spaced intervals on the interior surface 101 of the wheel rim 10.

With reference to FIGS. 2, 5, and 6, each one of the multiple interior protrusions 11 has a mounting hole 111 and a thickening portion 112. The mounting hole 111 is configured for receiving a respective one of the multiple connecting pins 20. The thickening portion 112 is formed on the interior surface 101 of the wheel rim 10 and located between the mounting hole 111 and the interior surface 101. The thickening portion 112 thickens the portion of the wheel rim 10 adjacent to the mounting hole 111, which ensures that the portion of the wheel rim 10 adjacent to the connecting pin 20 has sufficient structural strength.

With reference to FIGS. 2, 5, and 6, each one of the multiple connecting pins 20 is rotatably accommodated in the mounting hole 111 of a respective one of the multiple interior protrusions 11 of the wheel rim 10, wherein the mounting hole 111 of each one of the multiple interior protrusions 11 extends along an axial direction A of the wire wheel; i.e. the multiple connecting pins 20 are disposed along the axial direction A. Each one of the multiple connecting pins has a first connecting hole 21 for being connected to the corresponding wire spoke 40.

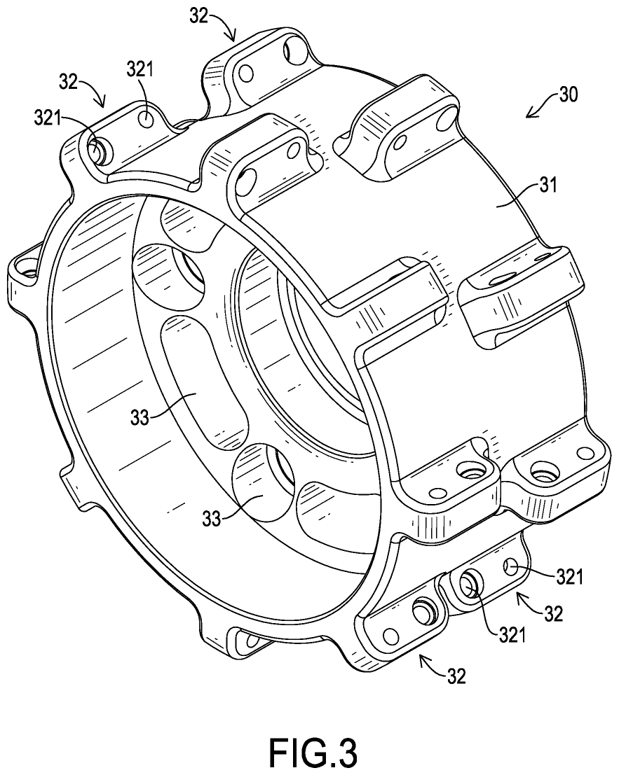

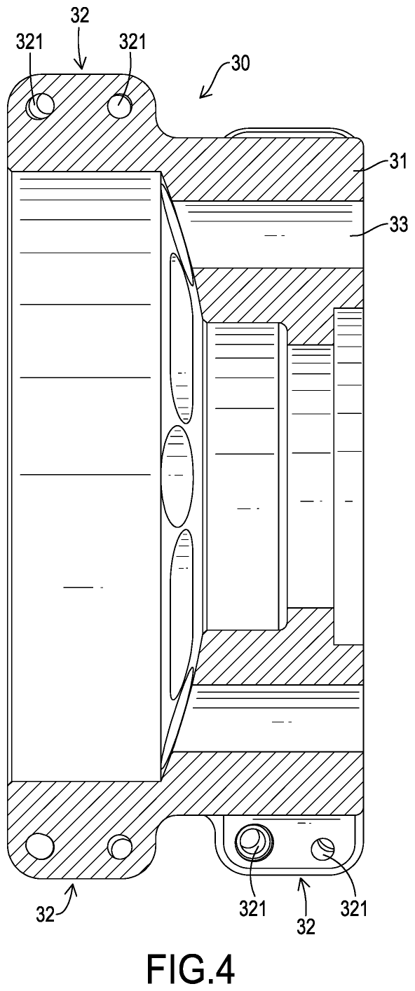

With reference to FIGS. 3 and 4, the hub 30 is formed in one piece and has multiple connecting protrusions 32 formed on a periphery of the hub 30; specifically, the hub 30 has a main body 31 having a cylindrical construction and a peripheral surface. The multiple connecting protrusions 32 radially protrude from the peripheral surface of the main body 31 and are divided into two groups. The two groups of said connecting protrusions 32 are both arranged circularly and are staggered with each other. In the first preferred embodiment, said connecting protrusions 32 in each one of the two groups of said connecting protrusions 32 are arranged at equiangular intervals.

With reference to FIGS. 3 to 5 and 8, each one of the multiple connecting protrusions 32 has two second connecting holes 321 defined therethrough for being connected to said wire spokes 40. Specifically, each one of the multiple connecting protrusions 32 radially protruding from the main body 31 has two side surfaces 324; the two second connecting holes 321 extend obliquely from one of the two side surfaces 324 to the other one of the two side surfaces 324, and the two second connecting holes 321 respectively extend along two different directions to be unparallel.

With reference to FIG. 3, in the first preferred embodiment, the hub 30 has multiple through holes 33 axially defined through the main body 31 of the hub 30 and spaced from each other, which lightens a weight of the hub 30 without reducing the strength of the hub too much.

With reference to FIGS. 2 and 5, each one of the multiple wire spokes 40 between the wheel rim 10 and the hub 30 is inclined toward a tangent line of the hub 30 and has two opposite ends respectively being a rim end 401 and a hub end 402. The rim end 401 is mounted through the corresponding interior protrusion 11 to be connected to the first connecting hole 21 of the corresponding connecting pin 20, and the hub end 402 is connected to one of two second connecting holes 321 of a respective one of the multiple connecting protrusions 32. In the first preferred embodiment, the rim end 401 of said wire spoke 40 is threaded with the first connecting hole 21 of the corresponding connecting pin 20, and the hub end 402 of said wire spoke 40 is engaged with the corresponding second connecting hole 321 of the corresponding connecting protrusion 32.

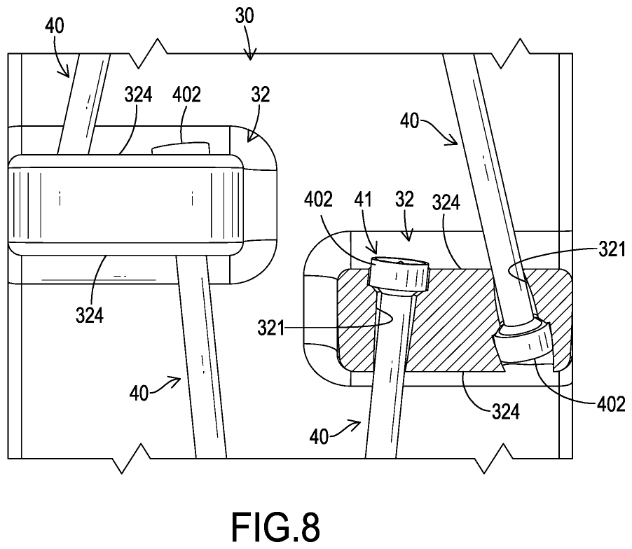

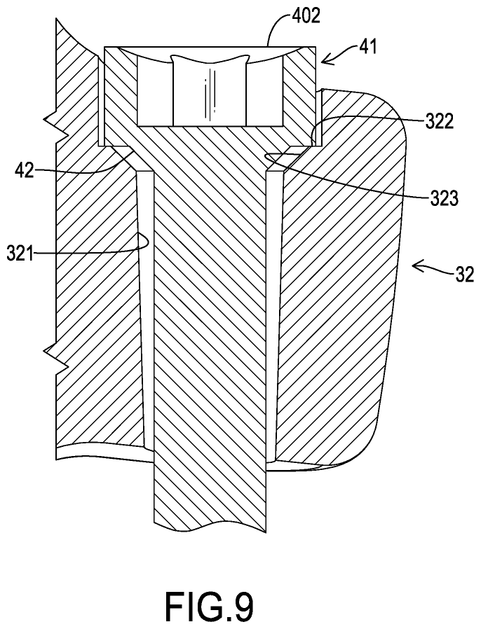

Specifically, with reference to FIG. 5, the first connecting hole 21 of said connecting pin 20 and the corresponding second connecting hole 321 on said connecting protrusion 32 are aligned with each other; with reference to FIGS. 8 and 9, said second connecting hole 321 is a counterbore hole and forms a containing groove 322 at a side of said connecting protrusion 32, and each one of the multiple wire spokes 40 has an engaging head 41 located at the hub end 402. The engaging head 41 is engaged in the containing groove 322 formed by said second connecting hole 321 such that the hub end 402 of said wire spoke 40 is connected to said second connecting hole 321.

The manufacturing process of the wire wheel of the preferred embodiment is roughly described below. The first step is to form a blank of the wheel rim 10 by forging, and then the second step is to machine an interior side of the wheel rim 10 to form the multiple interior protrusions 11 having said mounting holes 111 and form a hole on each interior protrusion 11 for said wire spoke 40 to be mounted therethrough. In the third step, the multiple connecting pins 20 are respectively received in said mounting holes of the multiple interior protrusions 11 and are rotated to align the first connecting hole 21 of each one of the multiple connecting pins 20 with the corresponding second connecting hole 321.

In the final step, the multiple wire spokes 40 are connected between the wheel rim 10 and the hub 30, wherein each one of the multiple wire spokes 40 is first mounted to the corresponding second connecting hole 321 to engage the engaging head 41 on the hub end 402 in the containing groove 322 formed by the corresponding second connecting hole 321.

With reference to FIG. 9, in the present invention, each one of the two second connecting holes 321 on said connecting protrusion 32 further forms a guiding surface 323 being annular around said second connecting hole 321 and tapering from the containing groove 322 toward the corresponding first connecting hole 21. When mounting said wire spoke 40 to the corresponding second connecting hole 321, the tapering guiding surface 323 is configured to guide the rim end 401 of said wire spoke 40 to enter and pass through the corresponding second connecting hole 321 for being connected to the corresponding first connecting hole 21.

Further, each one of the multiple wire spokes 40 has a leading portion 42 connected to the engaging head 41; the leading portion 42 tapers from the engaging head 41 toward the rim end 401 and has a taper angle corresponding to that of the guiding surface 323, such that the engaging head 41 can be exactly engaged in the containing groove 322.

Finally, the rim end 401 of each one of the multiple wire spokes 40 is connected to the first connecting hole 21 of the corresponding connecting pin 20; in the first preferred embodiment, the hub end 402 of said wire spoke 40 has a recess matching a screw driver such that a user can rotate said wire spoke 40 by the screw driver and drive the rim end 401 to be threaded with the connecting hole 21.

In the present invention, said connecting pin 20 received in said mounting hole 111 can be rotated to align the first connecting hole 21 with the corresponding second connecting hole 321 of said connecting protrusion 32, which allows said wire spoke 40 to extend straight from said connecting protrusion 32 toward said interior protrusion 11. Thereby, said wire spoke 40 can be designed straight without any bent portion such that each one of the multiple wire spokes 40 is configured to withstand shock with their complete strength. In comparison with the conventional wire wheel having wire spokes with a bent portion, the performance of the wire wheel can thus be improved.

Also, the hub 30 formed in one piece has greater strength and less cumulative tolerance in comparison with conventional hubs having several components formed respectively first and then connected.

Further, the guiding surface 323 guiding the rim end 401 of said wire spoke 40 and the leading portion 42 leading the engaging head 41 improve not only convenience but also stability of assembling of the multiple wire spokes. Each one of the multiple wire spokes 40 can be accurately aligned with and connected to the corresponding first and second connecting holes 21, 321, which improves shock-resistance of the wire wheel.

With all the configurations above, the present invention provides the wire wheel that has wire spokes 40 designed straight to improve the performance and has great strength and stability to reduce wear and improve shock-resistance.

With reference to FIGS. 2, 6, and 7, in the first preferred embodiment, each one of the multiple connecting pins 20 has two cylindrical portions connected to each other and respectively being a first cylindrical portion 22 and a second cylindrical portion 23. The first cylindrical portion 22 has a diameter larger than that of the second cylindrical portion 23 such that the two cylindrical portions form a step structure 24 on a middle section of said connecting pin 20.

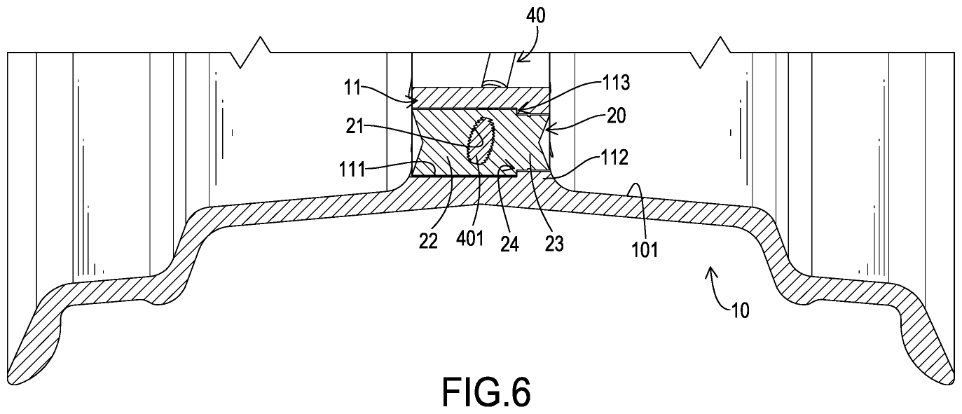

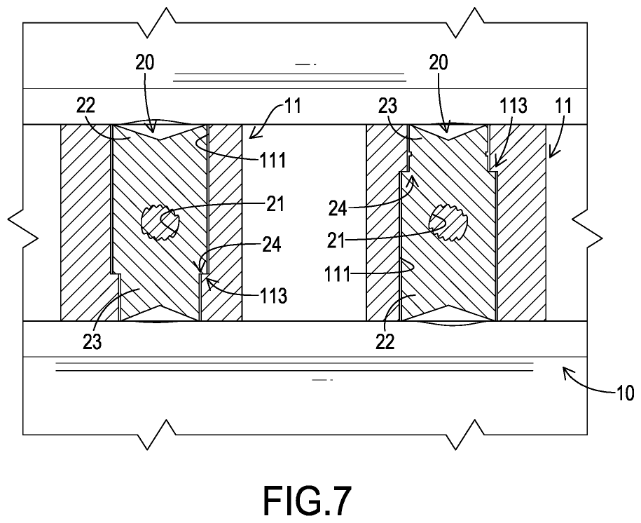

With reference to FIGS. 6 and 7, correspondingly, each one of the multiple interior protrusions 11 has an annular step structure 113 formed around the mounting hole 111. When received in said mounting hole 111, the step structure 24 of said connecting pin 20 is engaged with the annular step structure 113 around the corresponding mounting hole 111, which allows said connecting pin 20 to be stably received in the corresponding mounting hole 111.

With reference to FIG. 7, further, in the first preferred embodiment, said annular step constructions 113 of adjacent two of the multiple interior protrusions 11 are parallel to a central axis of the wire wheel and respectively face two opposite directions; i.e. the two connecting pins 20 received in said mounting holes 111 of the adjacent two interior protrusions 11 are disposed oppositely in said mounting holes, which further prevents said connecting pin 20 from being detached from the corresponding mounting hole 111.

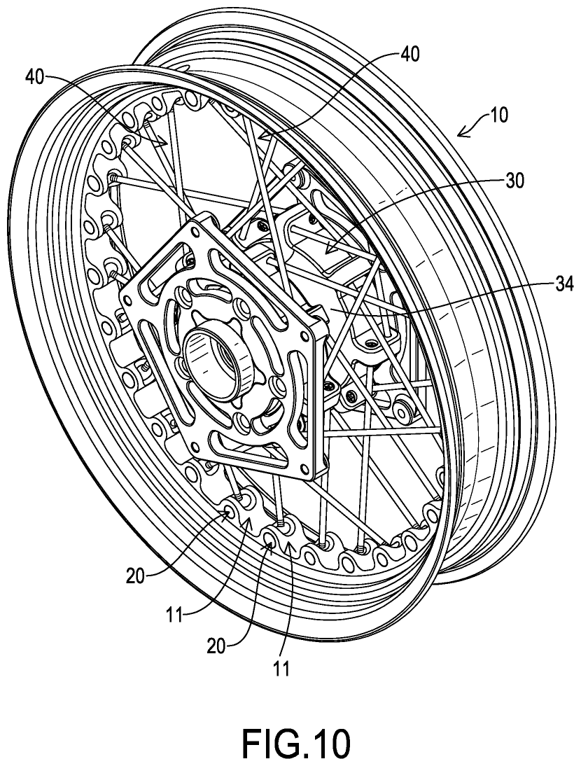

FIGS. 10 to 13 show the wire wheel for tubeless tire of a second preferred embodiment in accordance with the present invention. Differences between the second preferred embodiment and the first preferred embodiment are sequentially described below.

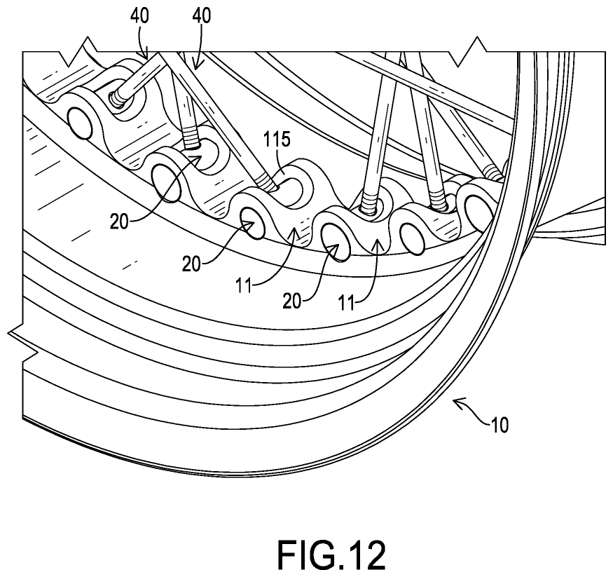

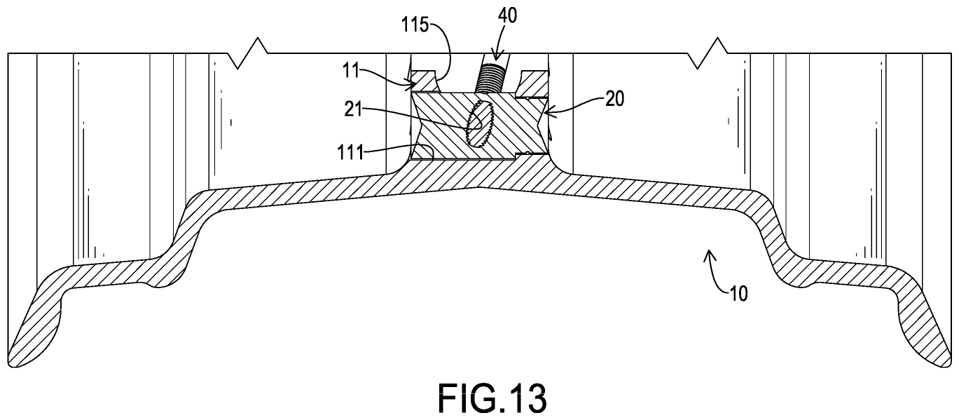

With reference to FIGS. 12 and 13, in the second preferred embodiment, each one of the multiple interior protrusions 11 has a recess 115. The recess 115 is recessed from a top side of said interior protrusion 11 away from the interior surface 101 toward the interior surface 101; the recess 115 communicates with the mounting hole 111 and an exterior of said interior protrusion 11 and has a diameter larger than that of said connecting pin 20. Thereby, each one of the multiple connecting pins 20 is configured to be accommodated in the mounting hole 111 of the corresponding interior protrusion 11 from the recess 115, which improves convenience of assembly.

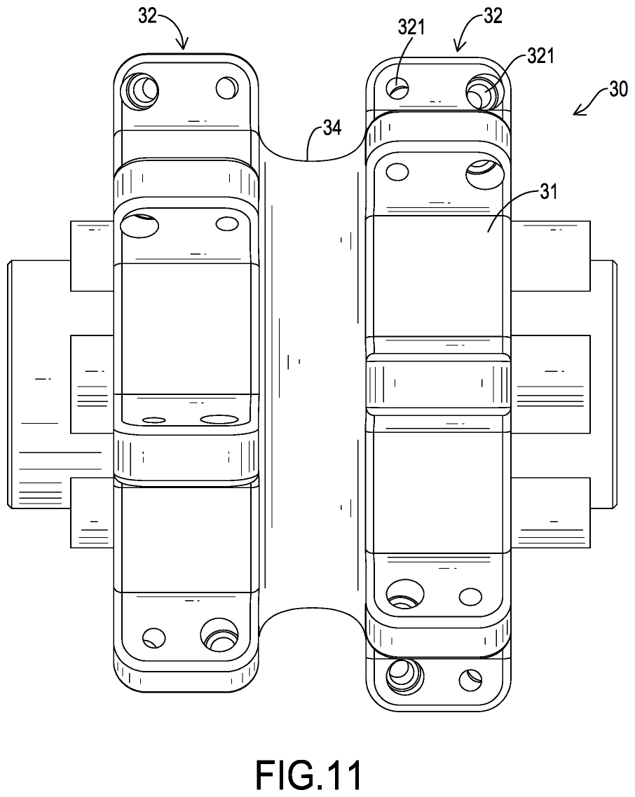

With reference to FIG. 11, additionally, in the second preferred embodiment, the hub 30 has an annular groove 34 recessed thereon and located between the two series of said connecting protrusions 32, which lightens the weight of the hub 30 without reducing the strength of the hub 30 too much.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A wire wheel for a tubeless tire comprising:
a wheel rim having
multiple interior protrusions protruding from an interior surface of the wheel rim and arranged circularly, and each one of the multiple interior protrusions having
a mounting hole formed therein and extending along an axial direction of the wire wheel; and
a thickening portion formed on the interior surface of the wheel rim and located between the interior surface and the mounting hole;
multiple connecting pins, each one of the multiple connecting pins rotatably received in the mounting hole of a respective one of the multiple interior protrusions and having
a first connecting hole defined thereon;
a hub formed in one piece, disposed at a center of the wheel rim, and having
multiple connecting protrusions formed on a periphery of the hub and divided into two groups, each group arranged circularly, and each one of the multiple connecting protrusions having
two second connecting holes defined therethrough, spaced from each other, and respectively extending along two different directions; each one of the two second connecting holes aligned with the first connecting hole of a respective one of the multiple connecting pins and forming
a containing groove located at a side of said connecting protrusion away from the corresponding first connecting hole; and
a guiding surface being annular and tapering from the containing groove toward the other side of said connecting protrusion; and
multiple wire spokes, each one of the multiple wire spokes inclined toward a tangent direction of the hub and having
a rim end mounted through a respective one of the multiple interior protrusions and connected to the first connecting hole of a respective one of the multiple connecting pins;
a hub end being opposite to the rim end and connected to one of the two second connecting holes of a respective one of the multiple connecting protrusions;
an engaging head located on the hub end and engaged in the containing groove formed by the corresponding second connecting hole; and
a leading portion connected to the engaging head and tapering from the engaging head toward the rim end.

2. The wire wheel for a tubeless tire as claimed in claim 1, wherein
each one of the multiple connecting pins has two cylindrical portions connected to each other and having different diameters to form a step structure; and
each one of the multiple interior protrusions has an annular step structure formed around the mounting hole to match the step structure of the corresponding connecting pin.

3. The wire wheel for a tubeless tire as claimed in claim 2, wherein
said annular step structures of adjacent two of the multiple interior protrusions are parallel to a central axis of the wire wheel and respectively face two opposite directions; and
two of the multiple connecting pins received in said mounting holes of adjacent two of the multiple interior protrusions are disposed oppositely.

4. The wire wheel for a tubeless tire as claimed in claim 1, wherein
each one of the multiple interior protrusions has
a recess recessed from a side of said interior protrusion away from the interior surface of the wheel rim toward the interior surface of the wheel rim and communicating with the mounting hole.

5. The wire wheel for a tubeless tire as claimed in claim 1, wherein the hub has multiple through holes axially defined therethrough.

6. The wire wheel for a tubeless tire as claimed in claim 2, wherein the hub has multiple through holes axially defined therethrough.

7. The wire wheel for a tubeless tire as claimed in claim 3, wherein the hub has multiple through holes axially defined therethrough.

8. The wire wheel for a tubeless tire as claimed in claim 4, wherein the hub has multiple through holes axially defined therethrough.

9. The wire wheel for a tubeless tire as claimed in claim 1, wherein the hub has an annular groove recessed thereon and located between the two groups of said connecting protrusions.

10. The wire wheel for a tubeless tire as claimed in claim 2, wherein the hub has an annular groove recessed thereon and located between the two groups of said connecting protrusions.

11. The wire wheel for a tubeless tire as claimed in claim 3, wherein the hub has an annular groove recessed thereon and located between the two groups of said connecting protrusions.

12. The wire wheel for a tubeless tire as claimed in claim 4, wherein the hub has an annular groove recessed thereon and located between the two groups of said connecting protrusions.

13. The wire wheel for a tubeless tire as claimed in claim 1, wherein the multiple wire spokes have a same length.

14. The wire wheel for a tubeless tire as claimed in claim 2, wherein the multiple wire spokes have a same length.

15. The wire wheel for a tubeless tire as claimed in claim 3, wherein the multiple wire spokes have a same length.

16. The wire wheel for a tubeless tire as claimed in claim 4, wherein the multiple wire spokes have a same length.

17. The wire wheel for a tubeless tire as claimed in claim 1, wherein the multiple wire spokes have different lengths.

18. The wire wheel for a tubeless tire as claimed in claim 2, wherein the multiple wire spokes have different lengths.

19. The wire wheel for a tubeless tire as claimed in claim 3, wherein the multiple wire spokes have different lengths.

20. The wire wheel for a tubeless tire as claimed in claim 4, wherein the multiple wire spokes have different lengths.
